(19) United States
(12) Patent Application Publication
(10) Pub. No.: US 2004/0036582 A1
(43) Pub. Date: Feb. 26, 2004

(54) Vehicle security system and method

(76) Inventors: John Harvey, San Diego, CA (US); Thomas F. Doyle, San Diego, CA (US); Michael L. Segal, Carlsbad, CA (US)

Correspondence Address: Qualcomm Incorporated, Patents Department, 5775 Morehouse Drive, San Diego, CA, 92121-1714, US

(21) Appl. No.: 10/217,381

(22) Filed: Aug. 12, 2002

(51) Int. Cl. B60R 25/10

(52) U.S. Cl. 340/426.1

(57) ABSTRACT

A method and apparatus for detecting unauthorized use of a vehicle comprises, in one embodiment, an input device for allowing entry of vehicle operator identification information, and a processor for determining whether said vehicle is in operation, and for initiating an action if a vehicle operator has not been authorized to operate said vehicle prior to a predetermined event.

### BACKGROUND

I. Field of the Invention

The present invention relates to the field of vehicle security. More specifically, the present invention relates to a method and apparatus for providing vehicle security using a vehicle-based and/or host-based system to control vehicle functionality.

II. Description of the Related Art

Vehicle theft is a common problem throughout the world. In response to this problem, numerous vehicle theft-prevention devices have been developed. These devices range from simple mechanical locking mechanisms, to more complex electronic systems which are designed to prevent a vehicle from starting, or to limit or prevent movement of such a vehicle. In many electronic theft-prevention systems, operation of a vehicle is impaired until an authorized passcode is entered into the onboard theft-prevention device. If the passcode is authorized, the electronic theft-prevention system typically enables one or more vehicle systems to allow normal operation.

In some cases, it might be desirable to allow normal operation of a vehicle until a predetermined event occurs, before a passcode validation is required. For example, it might be desirable to allow a vehicle to operate normally until a predetermined operating time, a distance traveled, or a speed is reached. Additionally, it may be desirable to allow an entity remote from the vehicle to modify one or more predetermined events, or to implement new ones, if needed.

### SUMMARY

An apparatus for detecting unauthorized use of a vehicle. In one embodiment, an apparatus comprises an input device for allowing entry of vehicle operator identification information, and a processor for determining whether the vehicle is in operation, and for initiating an action if a vehicle operator has not been authorized to operate said vehicle prior to a predetermined event.

Alternatively, an apparatus for detecting unauthorized use of a vehicle comprises a signal-bearing medium tangibly embodying a program of machine-readable instructions executable by a digital processing apparatus to perform a method for detecting unauthorized use of the vehicle, the method comprising operations of determining whether the vehicle is in operation, detecting the occurrence a predetermined event after determining that the vehicle is in operation, and initiating an action if the vehicle is in operation, the predetermined event has occurred, and a vehicle operator has not been authorized to operate the vehicle prior to the predetermined event.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a satellite-based wireless communication system in which the apparatus for detecting unauthorized use of a vehicle is used;

FIG. 2 is a functional block diagram of one embodiment of an apparatus for detecting unauthorized use of a vehicle; and

FIG. 3 illustrates a flow diagram of a method for detecting unauthorized use of a vehicle.

### DETAILED DESCRIPTION

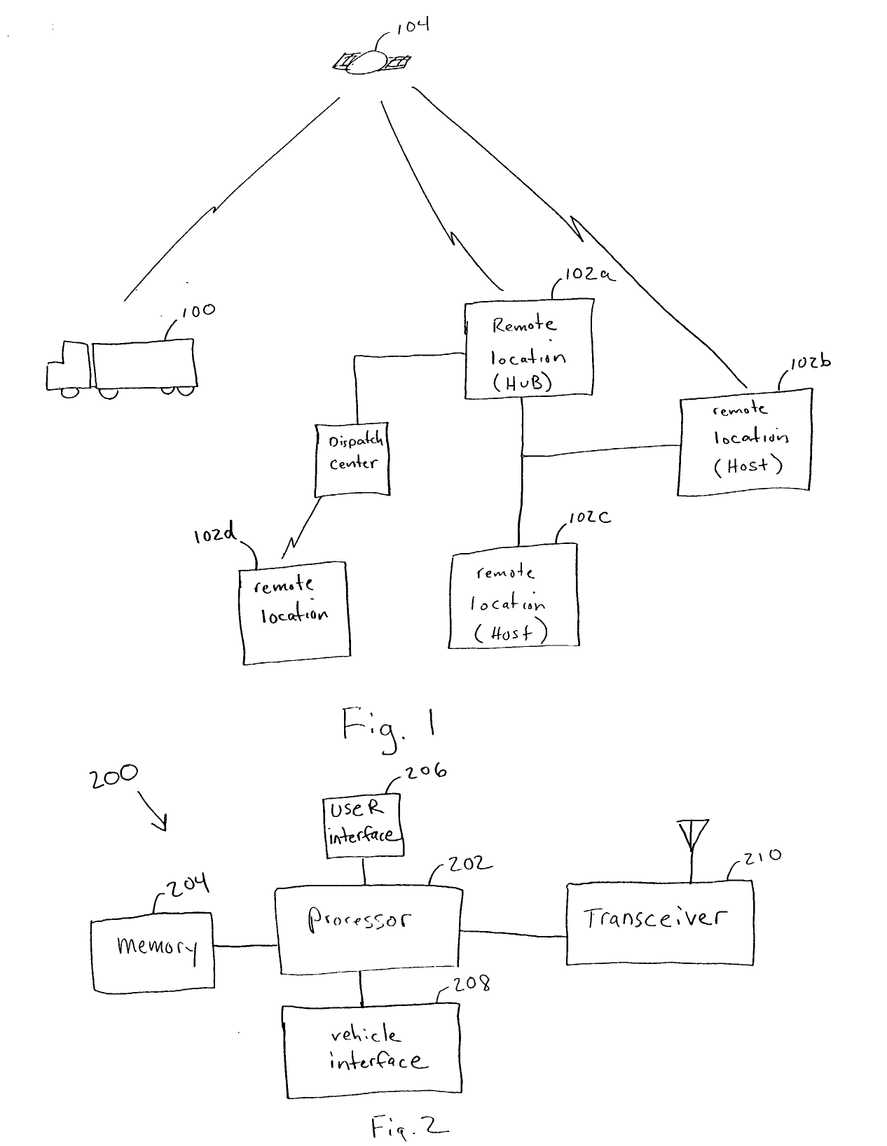

FIG. 1 illustrates a based-based wireless communication system widely used in the trucking industry for allowing two-way communications between vehicle operators and third parties, such as a fleet management center, family members, governmental authorities, and so on. Although the apparatus for detecting unauthorized use of a vehicle, in one or more embodiments, is described herein with respect to system a satellite-based communication system, it should be understood that any other wireless communication system could be used in the alternative, including cellular and PCS terrestrial communications, microwave communications, and so on. It should also be understood that the apparatus for detecting unauthorized use of a vehicle could also be used to validate operators of a number of different types of vehicles, such as buses, aircraft, automobiles, watercraft, or any other machine in which operator validation is desired.

As used throughout this specification, the term “validation” or “validate” means to determine whether or not a vehicle operator is authorized to operate a vehicle. Also, as used throughout, the term “vehicle operator” means any person who attempts to become validated, whether that person is a vehicle operator, a vehicle passenger, a vehicle maintenance worker, and so on.

Referring now to FIG. 1, vehicle 100, in this example, comprises a tractor-trailer, commonly used in the long-haul trucking industry. Vehicle 100 typically comprises a mobile communication terminal (MCT, not shown) for communicating with a remote location 102a via satellite 104. Generally, the MCT resides onboard a tractor portion of vehicle 100, in one embodiment. In one embodiment, remote location 102a comprises a central processing center, otherwise known as a “hub” or “network management center (NMC) and serves as a central communication point between MCT-equipped vehicles and their respective dispatch centers, other designated office(s), shippers, consignees, governmental authorities, family members, and so on. For example, in FIG. 1, remote location 102a passes communications between remote host or remote location 102b and vehicle 100. Remote location 102b comprises a vehicle dispatch center which generally monitors and controls a fleet of vehicles 100.

Communications between remote location 102b and vehicle 100 may further be passed to one or more other remote locations, such as remote location (host) 102c. Remote location 102c comprises any number of interested third parties to communications between remote location 102b and vehicle 100. For example, remote location 102c could be a another designated office of remote location 102b, a shipper of goods being carried by vehicle 100, a consignee of goods being carried by vehicle 100, a governmental unit, a personal computer, and so on. Communications among remote locations 102a, 102b, and 102c may be carried out by any known communication techniques, including telephone, internet, dedicated lines, wireless links, and so on.

In addition to remote locations 102a, 102b, and 102c, remote location 102d is shown which comprises a mobile entity, such as an emergency vehicle (police car, fire truck, etc), an individual, an aircraft, etc. Generally, communications between a remote location 102a and remote location 102d are routed through a dispatch center 106 associated with remote location 102d. Communications between dispatch center 106 and remote location 102d may employ any well-known wireless communication method, such as cellular, satellite, RF, Land Mobile Radio (LMR), or others.

Communications between dispatch center 106 and remote location 102a (or other remote locations 102) generally occur using landline communications, such as a telephone link, a fiber optic connection, the Internet, or others. Located onboard remote location 102d is a two-way wireless communication device which is able to send and receive information to and from one or more of the remote locations 102 or MCT 200. Remote location 102d might, for example, receive information identifying a certain vehicle 100 that is not operating with a validated vehicle operator operating the vehicle. Remote location may then transmit one or more commands to vehicle 100, either directly to vehicle 100 or through dispatch center 106, to disable, restrict, or impair the operation of vehicle 100.

In another embodiment, communications to and/or from vehicle 100 are transmitted directly to/from remote location 102b and/or 102c without being processed by a central communication center, such as remote location 102a.

The MCT located on vehicle 100 transmits and receives communications wirelessly using, in one embodiment, a satellite 104. In other embodiments, the MCT uses a terrestrial wireless communication system to communicate with remote location 102a, such as an analog or a digital cellular telephone system, an RF communication system, or a wireless data communication network, such as a cellular digital packet data (CDPD) network.

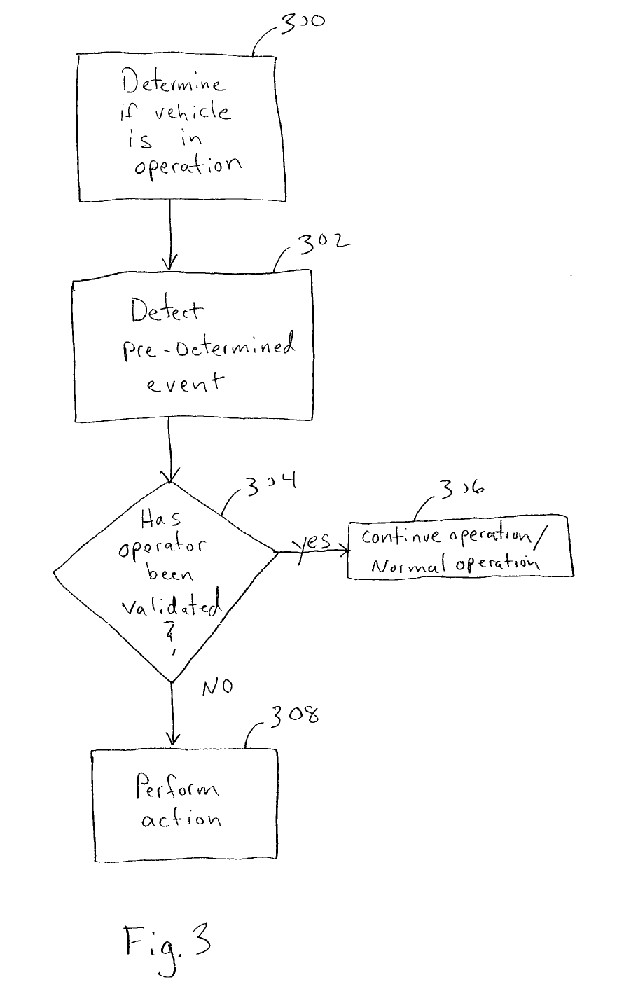

FIG. 2 is a functional block diagram of one embodiment of an apparatus 200 for detecting unauthorized use of a vehicle, comprising a processor 202, a memory 204, a user interface 206, a vehicle interface 208, and an optional transceiver 210. It should be understood that the functional blocks shown in FIG. 2 may be housed together in a single physical unit, or they may be distributed in any combination throughout vehicle 100. For example, the optional transceiver 210 may or may not be incorporated into the physical structure of apparatus 200. In another embodiment, transceiver 210 comprises an MCT, discussed above.

Processor 202 generally comprises circuitry necessary for executing machine-readable instructions stored in memory 204. For example, processor 202 may comprise a microprocessor and supporting circuitry, such as the Intel 80×86 or Pentium series of microprocessors. Of course, other electronic processors could be used in the alternative. Memory 204 may comprise one or more signal-bearing mediums tangibly embodying one or more programs of machine-readable instructions executable by a digital processing apparatus, such as processor 202. Typically, memory 204 comprises one or more volatile and/or non-volatile memories, such as a read-only memory (ROM), random-access memory (RAM), electrically erasable programmable read-only memory (EEPROM), a hard drive, a floppy disk drive and floppy disk, or a flash memory. Memory 204 is used to store instructions for the operation of apparatus 200 for detecting unauthorized use of vehicle 100. For example, instructions may be stored relating to the detection of certain vehicle operating characteristics, such as vehicle location, vehicle speed, engine RPM, load status, driver status, etc. Further, instructions may be stored for managing and controlling vehicle 100 in response to certain predetermined events. For instance, instructions may be stored within memory 204 for impairing operation of vehicle 100 under certain circumstances, as will be explained later herein.

User interface 206 allows a vehicle operator to enter instructions into processor 202, typically comprising a keyboard or keypad and a visual display device. Of course, user interface 206 could alternatively comprise other types of interfaces, such as a microphone for entering audible commands, a pointing device such as a mouse, light pen, trackball, and/or a speaker for generating audible information to a vehicle operator. Other types of well-known devices could be used, either alternatively or in combination, with the devices just mentioned. For example, vehicle operator interface may, alternatively or in addition, comprise a bio-metric device or a card reader.

Vehicle interface 208 allows processor 202 to communicate with one or more electronic control units (ECUs) located onboard vehicle 100, either directly, or through one or more intermediary devices, such as an onboard computer (not shown). Vehicle interface 208 comprises a communication port such as a serial data port for communicating, for example, with an onboard computer. Alternatively, vehicle interface 208 comprises a port for interfacing to a vehicle data bus, such as a J1708 data bus commonly used in vehicles today. Examples of ECUs include a fuel regulator/cutoff switch, an ignition controller, an electronic transmission controller, a steering wheel locking mechanism, and a brake activation unit. Other examples of ECUs include electronic devices which provide operational information about vehicle 100 to processor 202. For example, these types of ECUs comprise a speed sensor, an RPM sensor, an odometer, or a location sensor such as a GPS receiver.

In modem vehicles, the ECUs may be interconnected by a data bus, such as a data bus as specified in SAE J1708, a commonly known communication standard. The data bus is connected to vehicle interface 208 so that communications may take place between processor 202 and the various ECUs connected to the data bus.

Transceiver 210 comprises a transmitter to modulate information from processor 202 and convert the modulated information into high frequency signals suitable for wireless transmission. Similarly, transceiver 210 also comprises a receiver to convert received high frequency communication signals into signals suitable for demodulation and subsequent processing by processor 202.

A vehicle operator of vehicle 100, enters vehicle operator identification information into apparatus 200 using user interface 206, either prior to operating vehicle 100 or subsequently after initial use. The vehicle operator identification information typically comprises a passcode, such as a predefined vehicle operator name and password, although other types of information may be used to validate the vehicle operator, such as a social security number or, in general, a vehicle operator-defined numeric or alpha-numeric code used in combination (or not) with a password.

Alternatively, or in conjunction with one or more I/O devices just described, vehicle operator interface 206 comprises a biometric device, such as a fingerprint reader, retinal scanner, or voice recognition device. A vehicle operator then identifies himself/herself to apparatus 200 by providing the necessary biological identification information to user interface 206. In this case, the vehicle operator identification information comprises the biometric information.

FIG. 3 is a flow diagram illustrating a method for detecting unauthorized use of a vehicle. The method may be embodied as a set of machine-readable instructions executable by a digital processing apparatus and stored in memory 204. Vehicle 100 may be enabled to operate normally or it may be provisioned to operate in an restricted, or impaired, state of operation, where, for example, the speed of vehicle 100 could be limited to a predetermined speed.

In step 300, processor 202 determines whether or not vehicle 100 is in operation. Vehicle 100 is in operation when one or more predetermined operating characteristics of vehicle 100 are detected, generally by an ECU and presented to processor 202. A partial list of predetermined operating characteristics include starting an engine, sensing movement of vehicle 100 (for example, by measuring vehicle speed or a change in vehicle position), sensing vehicle RPM, and sensing the application or removal of brakes. When one or more of these conditions are sensed by one or more ECUs, information relating to the event is sent to processor 202 via the vehicle data bus and vehicle interface 208. Processor 208 then compares the information sent by the one or more ECUs to a set of predetermined events stored in memory 204. A partial list of predetermined events includes vehicle speed being greater than a predetermined amount, a change in vehicle position exceeding a predetermined amount, application or removal of brakes, RPM being greater than a predetermined amount, sensing engine startup, etc. Step 300 may additionally include processor 202 generating a notification of vehicle 100 being in motion, and transmit the notification to a remote location 102 via transceiver 210.

If processor determines that vehicle 100 is in operation in step 300, step 302 is performed, in which processor 202 determines whether a predetermined event has occurred. A partial list of pre-defined events comprise vehicle 100 exceeding a predetermined speed, vehicle movement exceeding a predetermined distance, RPM exceeding a certain predetermined amount, ignition being “on”, detection of vehicle 100 being in a predefined gear, passage of a predetermined amount of time since the detection of vehicle operation as determined in step 300, etc. Any of the preceding events could additionally be coupled with a time characteristic, for example, vehicle 100 exceeding a predetermined speed for greater than a predetermined amount of time, RPM exceeding a predetermined threshold for a predetermined amount of time, etc. Step 302 may additionally include processor 202 generating a notification of the predetermined event, and transmit the notification to a remote location 102 via transceiver 210.

If processor 202 determines that vehicle 100 is in operation (step 300) and that one or more predetermined events have occurred (step 302), processor 202 then determines whether or not a vehicle operator has been validated, as shown in step 304. Processor 202 determines whether or not a vehicle operator has been validated by knowing whether or not the vehicle operator has provided vehicle operator identification information to user interface 206, and whether or not the vehicle operator identification matches pre-determined identification information as stored in memory 204. As explained above, the vehicle operator identification information may comprise a vehicle operator name and password, biometric information, or other information. Optionally, processor 202 generates a notification that is transmitted to remote location 102 via transceiver 210 indicative of the validation status.

If processor 202 determines that the vehicle operator has not yet been validated, a request that the vehicle operator validate himself to apparatus 200, i.e., to enter vehicle operator identification information, may optionally be instituted by processor 202. The request is generally issued through vehicle operator interface 206. If the vehicle operator fails to validate himself to apparatus 200 within a predetermined time period after operating vehicle 100 for one mile, processing continues to step 308, where one or more actions are implemented by processor 202, as explained below. If the vehicle operator of vehicle 100 is successfully validated after validation is requested by processor 202, vehicle 100 will continue to operate normally, or processor 202 will instruct one or more ECUs to enable vehicle 100 to operate normally, if vehicle 100 was previously operating under in a restricted manner, as shown in step 306.

In an alternative embodiment, instead of determining validation onboard vehicle 100, processor 202 transmits the vehicle operator identification information and a request to remote location 102 for operator validation, using transceiver 210. At some time after the request for validation is transmitted, a response to the validation request is received by transceiver 210. The response contains an indication of whether validation of the vehicle operator was successful or not. Validation is performed at a remote location from vehicle 100, such as at remote location 102a, 102b, 102c, etc. in the same or similar manner as described in step 304, above.

If the vehicle operator has not been successfully validated in step 304, processor performs one or more actions, as shown in step 308. The action(s) are typically defined by the machine-readable instructions stored in memory 204 and used to control operation of vehicle 100. Alternatively, the instructions for control of vehicle 100 are contained in a message sent by remote location 102 in response to the optional notification sent in steps 400, 402, and/or 404. Typically, processor 202 uses the instructions to control one or more vehicle electronic control units (ECUs) connected through a vehicle data bus, which in turn is connected to vehicle interface 208.

Possible actions include controlling a fuel restrictor or fuel pump to limit or prevent fuel to pass normally from the fuel tank to one or more fuel injectors, carburetors, or the like, disabling or impairing one or more vehicle electronic subsystems, such as a vehicle ignition, a braking system (brakes would be applied in this case), an electronic or mechanical clutch or gearshift controller, or a steering wheel control system. Of course, other vehicle systems could be disabled or impaired by processor 202, either alternatively or in addition, to the examples just listed. In an embodiment where the vehicle is operating in an impaired or restricted state, the action may include doing nothing, and allowing vehicle 100 to continue to operate in the restricted state. Alternatively, vehicle 100 could be disabled entirely from movement from the restricted state. An action may alternatively or in addition include activating a vehicle horn, headlights, taillights, or interior lights, locking or unlocking one or more doors, and so on.

The previous description of the preferred embodiments is provided to enable any person skilled in the art to make and use the present invention. The various modifications to these embodiments will be readily apparent to those skilled in the art, and the generic principles defined herein may be applied to other embodiments without the use of the inventive faculty. Thus, the present invention is not intended to be limited to the embodiments discussed herein, but is to be accorded the widest scope consistent with the principles and novel features disclosed herein.

I claim:

1. An apparatus for detecting unauthorized use of a vehicle, comprising:
an input device for allowing entry of vehicle operator identification information; and
a processor for determining whether said vehicle is in operation, and for initiating an action if a vehicle operator has not been authorized to operate said vehicle prior to a predetermined event.

2. The apparatus of claim 1, further comprising a vehicle interface connected to said processor for enabling communications between said processor and an electronic control unit, wherein said action comprises sending an instruction via said vehicle interface for controlling operation of said vehicle.

3. The apparatus of claim 2, wherein controlling operation of said vehicle comprises impairing operation of said vehicle.

4. The apparatus of claim 3, wherein impairing operation of said vehicle comprises disabling a vehicle ignition system.

5. The apparatus of claim 3, wherein impairing operation of said vehicle comprises impairing a vehicle fuel system.

6. The apparatus of claim 3, wherein impairing operation of said vehicle comprises flashing a vehicle headlight, a vehicle taillight, or a vehicle interior light.

7. The apparatus of claim 3, wherein impairing operation of said vehicle comprises sounding a vehicle horn.

8. The apparatus of claim 3, wherein impairing operation of said vehicle comprises impairing a vehicle transmission.

9. The apparatus of claim 8, wherein impairing operation of a vehicle transmission comprises limiting the number of gears that may be used during operation of said vehicle.

10. The apparatus of claim 1 further comprising a transmitter, wherein said action comprises sending a notification to a remote location indicative of said vehicle operator not being authorized to operate said vehicle prior to said predetermined event.

11. The apparatus of claim 10 further comprising a receiver for receiving a response to said notification, said response comprising instructions for performing said action.

12. A signal-bearing medium tangibly embodying a program of machine-readable instructions executable by a digital processing apparatus to perform a method for detecting unauthorized use of a vehicle, said method comprising operations of:
determining whether said vehicle is in operation;
detecting the occurrence of a predetermined event after determining that said vehicle is in operation; and
initiating an action if said vehicle is in operation, said predetermined event has occurred, and a vehicle operator has not been authorized to operate said vehicle prior to said predetermined event.

13. The signal-bearing medium of claim 12 wherein said action comprises sending an instruction via a vehicle interface for controlling operation of said vehicle.

14. The signal-bearing medium of claim 13, wherein controlling operation of said vehicle comprises impairing operation of said vehicle.

15. The signal-bearing medium of claim 14, wherein impairing operation of said vehicle comprises disabling a vehicle ignition system.

16. The signal-bearing medium of claim 14, wherein impairing operation of said vehicle comprises impairing a vehicle fuel system.

17. The signal-bearing medium of claim 14, wherein impairing operation of said vehicle comprises flashing a vehicle headlight, a vehicle taillight, or a vehicle interior light.

18. The signal-bearing medium of claim 14, wherein impairing operation of said vehicle comprises sounding a vehicle horn.

19. The signal-bearing medium of claim 14, wherein impairing operation of said vehicle comprises impairing a vehicle transmission.

20. The signal-bearing medium of claim 19, wherein impairing operation of a vehicle transmission comprises limiting the number of gears that may be used during operation of said vehicle.

21. The signal-bearing medium of claim 12, wherein said action comprises sending a notification to a remote location indicative of said vehicle operator not being authorized to operate said vehicle prior to said predetermined event.

22. The signal-bearing medium of claim 21 further comprising operations of receiving a response to said notification, said response comprising instructions for performing said action.
